(19) United States
(12) Patent Application Publication
(10) Pub. No.: US 2020/0211029 A1
(43) Pub. Date: Jul. 2, 2020

(54) METHODS AND SYSTEMS FOR PROCESSING CUSTOMER INQUIRIES

(71) Applicant: DiDi Research America, LLC, Mountain View, CA (US)

(72) Inventors: Xing SHI, Mountain View, CA (US); Kevin Knight, Mountain View, CA (US)

(73) Assignee: DiDi Research America, LLC, Mountain View, CA (US)

(21) Appl. No.: 16/236,959

(22) Filed: Dec. 31, 2018

(51) Int. Cl. G06Q 30/00; G06F 17/27; H04M 3/523

(52) U.S. Cl. CPC G06Q 30/016; H04M 3/5232; G06F 17/279

(57) ABSTRACT

Embodiments of the disclosure provide methods and systems for generating a customer inquiry processing model for processing customer inquiries. The method includes obtaining a conversation log comprising a plurality of conversation entries associated with a conversation between a customer and an agent. The method also includes identifying, from the conversation entries, a slot of key information and determining that the identified slot relates to an application program interface (API) call. The method also includes obtaining an API log comprising a plurality of API calls associated with the conversation, and identifying an API call from the API calls included in the API call log based on the identified slot. The method further includes associating the identified slot with the corresponding API call and generating a customer inquiry processing model for processing a customer inquiry based on information relating to the identified slot and the corresponding API call.

### TECHNICAL FIELD

The present disclosure relates to developing a machine learning model, and more specifically relates to developing a machine learning model for processing a customer inquiry based on natural language processing.

### BACKGROUND

Customers often seek assistance with products or services from a company providing the products or services. For example, a customer who needs technical support on how to use a product may call a customer service number and seek help from the company. The company may provide a customer service system to accommodate the customer's need. For instance, the company may have a group of agents to interact with customers via interactive voice response systems. However, these existing systems have significant drawbacks. For example, a customer may have to wait for a long period of time before being transferred to an agent, given the capacity of the customer service system and the number of customers being waiting. As another example, even when a customer gets to speak with an agent, the agent may not have the knowledge to address the customer's need, which wastes not only the customer's time but also the company's resources. It is desirable to provide systems and methods for processing customer inquiries more efficiently and more effectively.

### SUMMARY

Embodiments of the disclosure provide a computer-implemented method for generating a customer inquiry processing model for processing customer inquiries. The method includes obtaining a conversation log comprising a plurality of conversation entries associated with a conversation between a customer and an agent. The method also includes obtaining an application program interface (API) log comprising a plurality of API calls associated with the conversation, and identifying, from the conversation entries, a slot of key information. The method also includes determining that the identified slot relates to an API call and identifying an API call from the API calls included in the API call log based on the identified slot. The method further includes associating the slot with the corresponding API call and generating a customer inquiry processing model for processing a customer inquiry based on information relating to the slot and the corresponding API call.

Embodiments of the disclosure further disclose a system for generating a customer inquiry processing model for processing customer inquiries. The system includes one or more processors and one or more data storage devices storing instructions that, when executed, cause the one or more processors to perform operations including obtaining a conversation log comprising a plurality of conversation entries associated with a conversation between a customer and an agent. The operations also include obtaining an application program interface (API) log. The API log may include a plurality of API calls associated with the conversation. The operations further include identifying, from the conversation entries, a slot of key information, and determining that the identified slot relates to an API call and identifying an API call from the API calls included in the API call log based on the identified slot. The operations also include associating the slot with the corresponding API call and generating a customer inquiry processing model for processing a customer inquiry based on information relating to the slot and the corresponding API call.

Embodiments of the disclosure further disclose a non-transitory computer-readable medium storing instructions. When executed, the instructions cause one or more processors to perform operations including obtaining a conversation log comprising a plurality of conversation entries associated with a conversation between a customer and an agent. The operations also include obtaining an application program interface (API) log. The API log may include a plurality of API calls associated with the conversation. The operations further include identifying, from the conversation entries, a slot of key information, and determining that the identified slot relates to an API call and identifying an API call from the API calls included in the API call log based on the identified slot. The operations also include associating the slot with the corresponding API call and generating a customer inquiry processing model for processing a customer inquiry based on information relating to the slot and the corresponding API call.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary system for processing customer inquiries, in accordance with some embodiments of this disclosure.

FIG. 2 illustrates a schematic diagram of an exemplary computing device, in accordance with some embodiments of this disclosure.

FIG. 3 illustrates a schematic diagram of an exemplary memory module for generating a customer inquiry processing model, in accordance with some embodiments of this disclosure.

FIG. 4 illustrates an exemplary conversation log and an exemplary API log, in accordance with some embodiments of this disclosure.

FIG. 5 illustrates a flowchart of an exemplary process for updating a customer inquiry processing model, in accordance with some embodiments of this disclosure.

FIG. 6 illustrates a schematic diagram of an exemplary memory module for generating a customer inquiry processing model, in accordance with some embodiments of this disclosure.

FIG. 7 illustrates a flowchart of an exemplary process for generating a customer inquiry processing model, in accordance with some embodiments of this disclosure.

FIG. 8 illustrates a schematic diagram of an exemplary memory module for processing a customer inquiry, in accordance with some embodiments of this disclosure.

FIG. 9 illustrates a flowchart of an exemplary process for processing a customer inquiry, in accordance with some embodiments of this disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to a system for processing customer inquiries. The system may receive an inquiry from a user device associated with a customer. The system may also process the inquiry based on a customer inquiry processing model. For example, the system may generate a response by an agent device according to a customer inquiry processing model. The customer inquiry processing model may be trained (or updated) according to historical data of past conversations between customers and agents. The historical data may include slots of key information and corresponding actions of agents (e.g., application program interface (API) calls initiated by an agent).

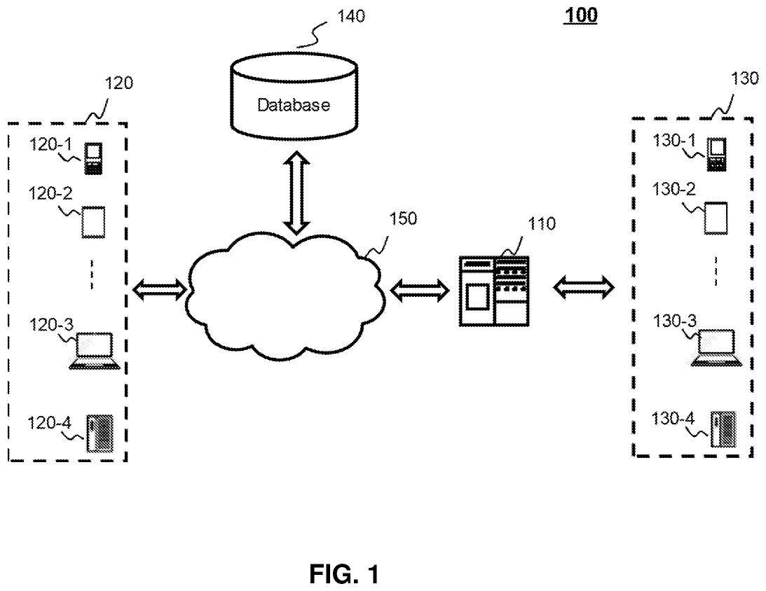

FIG. 1 is a diagram illustrating an exemplary system 100 for processing customer inquiries. As illustrated in FIG. 1, system 100 may include a server 110, one or more user devices 120, one or more agent devices 130, a database 140, and a network 150.

A customer may transmit an inquiry for support to server 110 via a user device 120 associated with the customer. For example, a customer may initiate an online chat using a chat box on a support website associated with server 110. The customer may also receive one or more responses from an agent (via, e.g., agent device 130).

In some embodiments, user device 120 associated with a customer may include a mobile device 120-1, a tablet computer 120-2, a laptop computer 120-3, a built-in device in a vehicle 120-4, a landline phone, or the like, or any combination thereof. In some embodiments, mobile device 120-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smartwatch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift, a HoloLens, a Gear VR, etc. In some embodiments, user device 120 may include a device with positioning technology (e.g., global positioning system or GPS) for locating the position of the customer and/or user device 120.

An agent may interact with the customer via agent device 130. For example, server 110 may forward a customer inquiry to agent device 130 associated with a human agent. The agent may respond to the customer via agent device 130. As another example, an agent interacting with the customer may include an automated virtual agent (also referred to herein as a “bot”). Agent device 130 may generate responses and/or take actions relating to the customer inquiry. For example, agent device 130 may execute an application program interface (API) call to update a customer's phone number based on the customer's request. In some embodiments, agent device 130 may include a mobile device 130-1, a tablet computer 130-2, a laptop computer 130-3, a built-in device in a vehicle 130-4, a landline phone, or the like, or any combination thereof. In some embodiments, mobile device 130-1 may include a smart device, a wearable device, a virtual reality device, an augmented reality device, or the like, or any combination thereof. In some embodiments, agent device 130 may include a device with positioning technology (e.g., global positioning system or GPS) for locating the position of the agent and/or agent device 130.

In some embodiments, agent device 130 may provide an application programming interface (API) through which an agent (a bot and/or human agent) may retrieve information and take actions in response to a customer's inquiry. For example, a customer may transmit an inquiry to update the phone number of record to server 110, which may forward the inquiry to agent device 130. Agent device 130 may retrieve the profile information of the customer based on the inquiry through the API (e.g., via a getUserInfo( ) call). Agent device 130 may also receive further information from the customer by interacting with the customer and update the phone number via an operation API call (e.g., via updatePhoneNumber( ) call). In some embodiments, API calls may include operations that enable an agent's application to invoke at runtime to take specific actions. Exemplary actions include querying data, adding, updating, and deleting, processing data (e.g., information relating to customers, company, third-parties, or the like, or a combination thereof).

In some embodiments, the agent involved in the conversation with the customer may include a human agent (real-time or off-line), an automated virtual agent (also referred to herein as “bot”), or the like, or a combination thereof. For example, a customer may initiate an online chat (i.e., a conversation) using a chat box on a customer support website. A bot may interact with the customer through a customer inquiry processing model. The bot may receive information relating to the inquiry of the customer and provide a potential solution to the customer. System 100 may also determine whether the bot can provide a satisfactory solution to the customer and if not, system 100 sends a request for a human agent to get involved in the conversation.

Database 140 or other external storage may include a volatile or non-volatile, magnetic, semiconductor, tape, optical, removable, non-removable, or another type of storage device or tangible or non-transitory computer-readable medium. Memory 220 and database 140 may include one or more memory devices that store data and instructions used to perform one or more features of the disclosed embodiments. Memory 220 and database 140 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

Network 150 may facilitate the exchange of information and/or data. In some embodiments, one or more components of system 100 (e.g., server 110, user device 120, agent device 130, database 140, etc.) may transmit information and/or data to another component (s) of system 100 via network 150. For example, server 110 may receive an inquiry from a user device 120 associated with a customer via network 150. In some embodiments, network 150 may be any type of wired or wireless network, or combination thereof. Merely by way of example, network 150 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, network 150 may include one or more network access points. For example, network 150 may include wired or wireless network access points, through which system 100 may be connected to network 150 to exchange data.

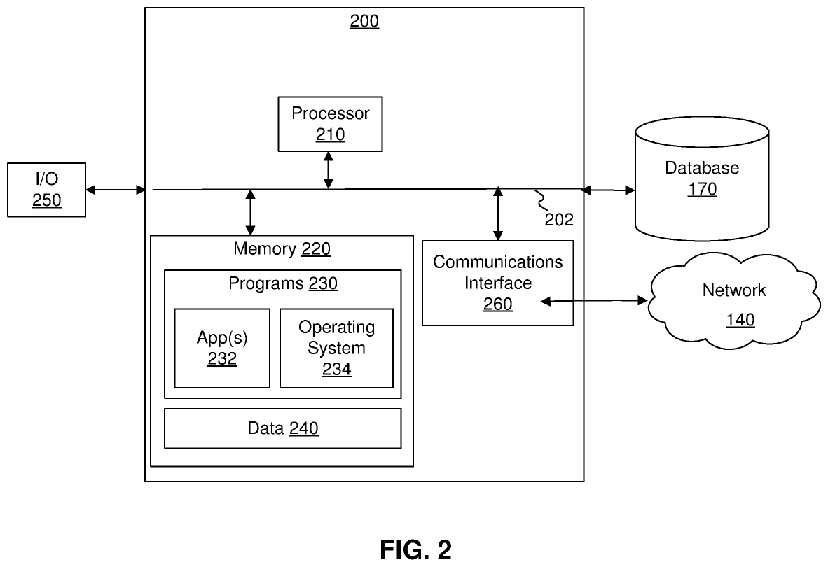

FIG. 2 is a diagram illustrating the components of an exemplary computing device 200 configured to perform methods or processes provided in embodiments of the present disclosure. For example, server 110, user device 120, and/or agent device 130 may be implemented using architecture and components of computing device 200. Computing device 200 may be configured to perform process 500, 700, or 900, or a combination thereof.

As shown in FIG. 2, computing device 200 may include a bus 202 (or other communication mechanisms), which interconnects subsystems and components for transferring information within computing device 200. Computing device 200 may also include one or more processors 210, one or more memories 220 storing programs 230 including, for example, app(s) 232, operating system 234, and data 240, and a communications interface 260 (e.g., a modem, Ethernet card, or any other interface configured to exchange data with a network, such as network 150 in FIG. 1). Computing device 200 may communicate with an external database 140 (which, for some embodiments, may be included within computing device 200).

In some embodiments, computing device 200 may include a single server (e.g., computing device 200) or may be configured as a distributed computer system including multiple servers, server farms, clouds, or computers that interoperate to perform one or more of the processes and functionalities associated with the disclosed embodiments. The term “cloud server” refers to a computer platform that provides services via a network, such as the Internet. When computing device 200 is a cloud server it may use virtual machines that may not correspond to individual hardware. Specifically, computational and/or storage capabilities may be implemented by allocating appropriate portions of desirable computation/storage power from a scalable repository, such as a data center or a distributed computing environment.

Processor 210 may be one or more processing devices configured to perform functions of the disclosed methods, such as a microprocessor manufactured by Intel™ or manufactured by AMD™. Processor 210 may comprise a single core or multiple core processors executing parallel processes simultaneously. For example, processor 210 may be a single core processor configured with virtual processing technologies. In certain embodiments, processor 210 may use logical processors to simultaneously execute and control multiple processes. Processor 210 may implement virtual machine technologies, or other technologies to provide the ability to execute, control, run, manipulate, store, etc. multiple software processes, applications, programs, etc. In some embodiments, processor 210 may include a multiple-core processor arrangement (e.g., dual, quad-core, etc.) configured to provide parallel processing functionalities to allow computing device 200 to execute multiple processes simultaneously. It is appreciated that other types of processor arrangements could be implemented that provide for the capabilities disclosed herein.

Memory 220 may be a volatile or non-volatile, magnetic, semiconductor, tape, optical, removable, non-removable, or another type of storage device or tangible or non-transitory computer-readable medium that stores one or more program(s) 230 such as apps 232 and operating system 234, and data 240. Common forms of non-transitory media include, for example, a flash drive, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Computing device 200 may include one or more storage devices configured to store information used by processor 210 (or other components) to perform certain functions related to the disclosed embodiments. For example, computing device 200 may include memory 220 that includes instructions to enable processor 210 to execute one or more applications, such as apps 232, operating system 234, and any other type of application or software known to be available on computer systems. Alternatively or additionally, the instructions, application programs, etc., may be stored in an external database 140 (which can also be internal to computing device 200) or external storage communicatively coupled with computing device 200 (not shown), such as one or more database or memory accessible over network 150.

In some embodiments, computing device 200 may be communicatively connected to one or more remote memory devices (e.g., remote databases (not shown)) through network 150 or a different network. The remote memory devices can be configured to store information that computing device 200 can access and/or manage. By way of example, the remote memory devices may include document management systems, Microsoft SQL database, SharePoint databases, Oracle™ databases, Sybase™ databases, or other relational databases. Systems and methods consistent with disclosed embodiments, however, are not limited to separate databases or even to the use of a database.

Programs 230 may include one or more software modules causing processor 210 to perform one or more functions of the disclosed embodiments. Moreover, processor 210 may execute one or more programs located remotely from one or more components of system 100. For example, computing device 200 may access one or more remote programs that, when executed, perform functions related to disclosed embodiments.

In the presently described embodiment, app(s) 332 may cause processor 210 to perform one or more functions of the disclosed methods. For example, a customer may initiate a conversation with an agent via an application installed on a mobile phone (i.e., a user device 120).

In some embodiments, program(s) 230 may include operating system 234 performing operating system functions when executed by one or more processors such as processor 210. By way of example, operating system 234 may include Microsoft Windows™, Unix™, Linux™, Apple™ operating systems, Personal Digital Assistant (PDA) type operating systems, such as Apple iOS, Google Android, Blackberry OS, Microsoft CE™, or other types of operating systems. Accordingly, the disclosed embodiments may operate and function with computer systems running any type of operating system 234. Computing device 200 may also include software that, when executed by a processor, provides communications with network 150 through communications interface 260 and/or a direct connection to one or more user devices 120.

In some embodiments, data 240 may include, for example, profiles of users, account information of users, profiles of agents, knowledge database, information relating to the previous inquiries of users, or the like, or a combination thereof.

Computing device 200 may also include one or more I/O devices 250 having one or more interfaces for receiving signals or input from devices and providing signals or output to one or more devices that allow data to be received and/or transmitted by computing device 200. For example, computing device 200 may include interface components for interfacing with one or more input devices, such as one or more keyboards, mouse devices, and the like.

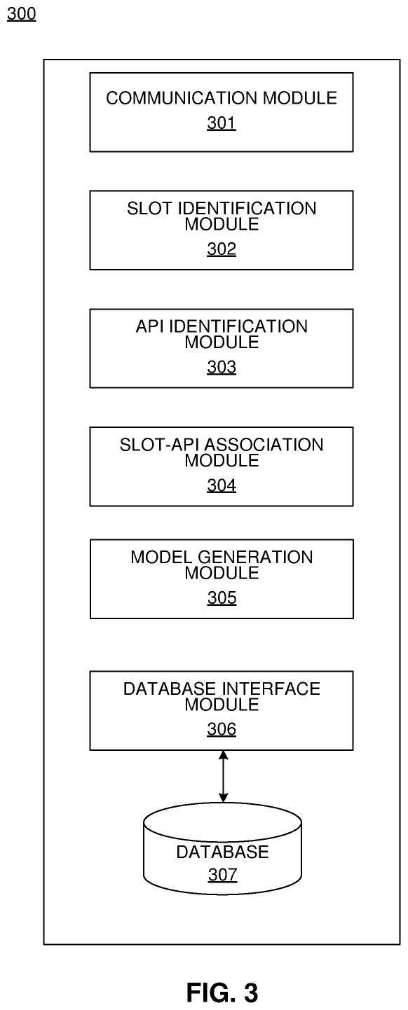

FIG. 3 depicts an embodiment of memory module 300 for generating (and/or updating) a customer inquiry processing model, in accordance with some embodiments of the present disclosure. Memory module may be implemented in memory 220 illustrated in FIG. 2. Memory module 300 may store a plurality of modules and may be executable by at least one processor to perform various methods and processes disclosed herein. Further, it should be noted that memory module 300 may store more or fewer modules than those shown in FIG. 3, depending on implementation-specific considerations.

As illustrated in FIG. 3, memory module 300 may store software instructions to execute a communication module 301, a slot identification module 302, an application program interface (API) identification module 303, a slot-API association module 304, a model generation module 305, a database interface module 306, and a database 307. Communication module 301 may include software instruction for communicating with other components of system 100 (e.g., user device 120, agent device 130). Slot identification module 302 may include software instruction for identifying one or more slots of key information from conversation entries. API identification module 303 may include software instruction for identifying an API call relating to a slot of key information. Slot-API association module 304 may include software instruction for associating the identified slot(s) and the corresponding API call(s). Model generation module 305 may include software instruction for generating (and/or updating) a customer inquiry model for processing customer inquiries based on the association of the slot and corresponding API. Database interface module 306 may include software instruction executable to interact with database 307, to store and/or receive information (e.g., conversation entries, API call logs, etc.).

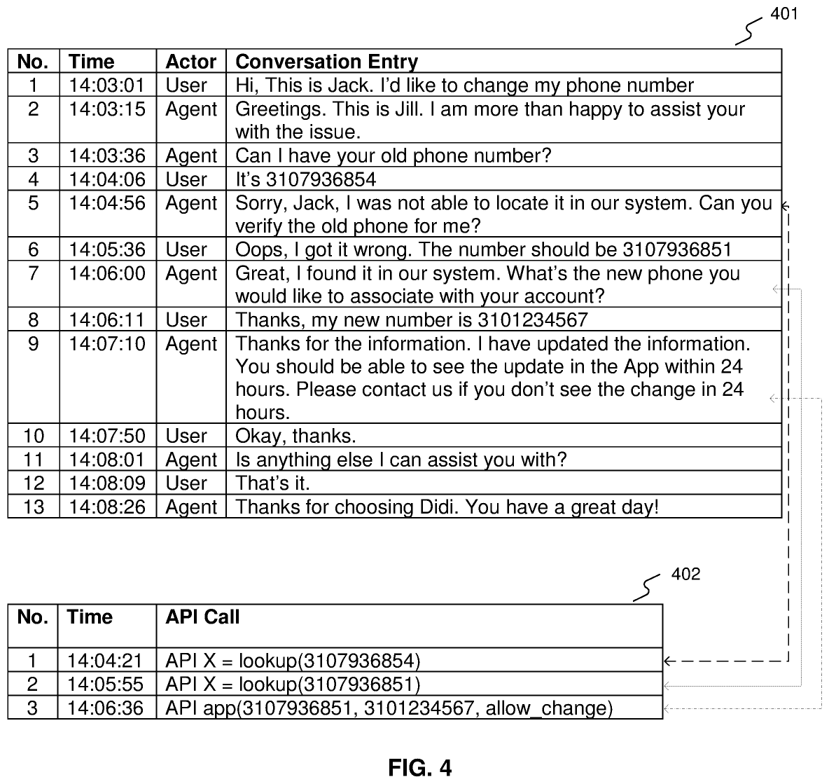

Communication module 301 may be configured to obtain a conversation log and an API log relating to a conversation between a customer and one or more agents. FIG. 4 illustrates an exemplary conversation log 401 and an API log 402. For example, conversation log 401 includes a transcript of an online chat between a customer and a human agent. An API log may include API calls initiated by the agent during the conversation. For instance, API log 402 includes three API calls activated by the agent during the conversation.

Slot identification module 302 may be configured to identify one or more slots of information from the conversation log. A slot of information (or key information) refers to a piece of information included in the conversation entries that is relevant to the customer's inquiry and/or agent's response. For example, for conversation entry No. 1 of conversation log 401, slot identification module 302 may identify “Jack” as a slot of information because the name is relevant to the customer's identity and for retrieving the customer's information. In some embodiments, slot identification module 302 may further determine a type of an identified slot. In some embodiments, slot identification module 302 may determine whether an identified slot relates to an API call.

API identification module 303 may be configured to identify an API call corresponding to the identified slot. For example, API identification module 303 may compare the conversation entry corresponding to the slot with one or more API entries of the API log, and determine whether the slot relates to an API call.

Slot-API association module 304 may be configured to associate the identified API call with the identified slot. For example, slot-API association module 304 may establish a link between conversation entry No. 5 and API entry No. 1 (i.e., corresponding to a slot and its associated API call), which is shown as the dashed line in FIG. 4. In some embodiments, slot-API association module 304 may generate and store one or more training samples based on the associated slot-API pair(s).

Model generation module 305 may be configured to update (or generate) a customer inquiry processing model based on the associated slot-API pair(s). For example, model generation module 305 may update a customer inquiry processing model based on the training sample(s) generated based on the slot-action pair(s).

Database interface module 306 may be configured to facilitate access by other components of system 100 (e.g., agent device 130) to the data stored in a database (e.g., database 140, database 307)

Database 307 may store data that can accessed by other components of system 100. Database 307 may include a volatile or non-volatile, magnetic, semiconductor, tape, optical, removable, non-removable, or another type of storage device or tangible or non-transitory computer-readable medium. The data stored in database 307 may include data relating to customers and/or agent (e.g., profile information of customers and/or agents), knowledge base, one or more customer inquiry processing models generated as described elsewhere in this disclosure, training samples, historical conversations, or the like, or a combination thereof.

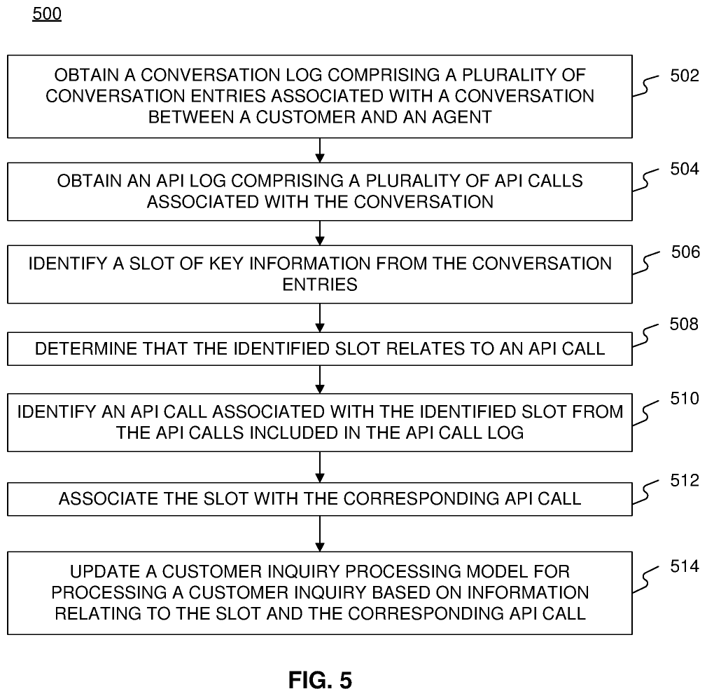

FIG. 5 is a flowchart showing an exemplary process 500 for updating a customer inquiry processing model, in accordance with some embodiments of the present disclosure. In one embodiment, the steps of process 500 may be performed by server 110 and/or agent device 130.

In 502, communication module 301 may obtain a conversation log relating to a conversation between a customer and an agent. For example, communication module 301 may receive conversation log 401 illustrated in FIG. 4, which includes a transcript of an online chat between a customer and a human agent.

The conversation may in the form of a video, a telephonic call, an online chat, an email chain, postings on an online forum, instant messaging, short message service (SMS), multimedia messaging service (MMS), hypertext, file transfer, data exchange, or the like, or a combination thereof. An online chat may occur between the customer and an agent via an application installed in a user device associated with the customer or an online chat tool on a website. A conversation log may be generated based on the conversation between a customer and one or more agents. For example, a conversation log may be generated by applying, by system 100, voice recognition to the verbal exchange to obtain a textual transcription of a phone call between a customer and agent. In some embodiments, inconsequential portions of the conversation may be identified and deleted from the conversation, and thus excluded from the conversation log. System may also generate an API log including the API call(s) made during (or relating to) the conversation.

In some embodiments, a conversation log may include relevant information relating to the conversation. For example, a conversation log may include time information (e.g., timestamps) of conversation entries, the profile and account information of the customer, the profile information of the agent, or the like, or a combination thereof.

In 504, communication module 301 may receive an API log relating to the conversation. An API log may include API calls initiated by the agent during the conversation. For example, communication module 301 may receive API log 402, which includes three API calls made by the agent during the conversation.

In some embodiments, an API log may also include relevant information relating to the API calls. For instance, an API log may include the time information (e.g., timestamps) of the API calls, the information of agent device 130 activating the API calls, the information retrieved in response to an API call, the results of executing an API call, or the like, or a combination thereof. By way of example, an API log may include customer information retrieved in response to a query API call (e.g., API X=lookup (“jack”; “name”)) for the customer's profile information. As another example, the API log may also include a result of updating the customer's phone number in response to an operation API call by the agent to update the customer's phone number upon the customer's inquiry. As a further example, the API log may include an error message indicating that no record has been identified in response to an API query call made by the agent for looking up a customer's record.

In some embodiments, an API log may further include one or more identifiers of the context conversation included in a conversation log (and the conversation). Alternatively or additionally, a conversation entry of a conversation log may include one or more identifiers of the corresponding API call(s).

In 506, slot identification module 302 may identify one or more slots of information from the conversation log. A slot of information (or key information) refers to a piece of information included in the conversation entries that is relevant to the customer's inquiry and/or agent's response. For example, for conversation entry No. 1 of conversation log 401, slot identification module 302 may identify “Jack” as a slot of information because the name is relevant to the customer's identity and for retrieving the customer's information.

In some embodiments, slot identification module 302 may identify a slot using an extraction process based on named-entity recognition (NER). For example, slot identification module 302 may identify and segment the named entities included in a conversation entry, and categorize the identified named entities under various predefined classes. Slot identification module 302 may also aggregate similar conversation entries into one slot. Slot identification module 302 may further identify the different portions among the similar conversation entries.

In some embodiments, slot identification module 302 may further determine a type of an identified slot. Exemplary type of a slot includes one of information provided by a customer, information relating to an agent, result retrieved (or returned) by calling an API by agent device 130, and the whole conversation entry being a slot. For example, slot identification module 302 may determine that a slot is provided by the customer (e.g., the name “Jack” is provided by the customer during the conversation), and accordingly determine the slot to be a type A slot. As another example, slot identification module 302 may identify name “Jill” being related to the agent, and determine the slot to be a type B slot. As still another example, slot identification module 302 may identify the phrases “I was not able to locate it in our system” and “I found it in our system” to be two slots relating to results of API calls made by agent device 130, and determine that these two slots be type C slots. As yet another example, a driver-for-hire (i.e., a customer) may call the customer service to complain that he has not been assigned any ride request in last two hours. An agent may respond during the phone call that “Please go to the Chinatown area, which is a hot area now.” Slot identification module 302 may determine that the agent's response (the whole sentence) is a slot, and further determine that the slot being the whole sentence is a type D slot.

In some embodiments, slot identification module 302 may identify the type of a slot based on a statistical method. For example, slot identification module 302 may obtain statistical data regarding the relationship between slots and corresponding types established according to historical slot-type data. By way of example, the statistical data may indicate that a slot including a phrase like “not able to find” has a probability of 90% of being a type C slot. Slot identification module 302 may determine a type of the identified slot based on the statistical data.

In some embodiments, slot identification module 302 may identify the type of a slot based on a model for determining a type of a slot that is trained by machine learning. For example, system 100 may train and generate the model according to training samples (e.g., labeled slot-type pairs). Slot identification module 302 may input the identified slot into the model and obtain a type as the output of the model.

In some embodiments, slot identification module 302 may also perform one or more additional actions based on the type of a slot. For example, if a slot is a type A slot (i.e., a slot including information provided by a customer), slot identification module 302 may also determine the span in the conversation that provides the information. For instance, slot identification module 302 may determine whether one or more neighboring slots (which occur before and/or after the slot) also include the information. Slot identification module 302 may determine the span of the slot by including the neighboring slot(s). As another example, if a slot is a type B slot (i.e., a slot relating to the agent's profile), slot identification module 302 may determine which field of the agent relates to the slot. By way of example, slot identification module 302 may identify the information “Jill” provided by the agent as a type B slot, and further determine the related field of the agent profile is field “name.” Slot identification module 302 may scan the agent's profile to identify the field of the agent's profile relating to the identified slot.

In 508, slot identification module 302 may determine whether an identified slot relates to an API call. For example, for conversation entry No. 5 of conversation log 401 illustrated in FIG. 4, slot identification module 302 may determine that the phrase “I was not able to locate it in our system” to be a type C slot (i.e., a result returned by calling certain API). Slot identification module 302 may also determine that the slot relates to an API call for checking the customer's profile. As another example, if a slot is a type D slot (i.e., the whole sentence or conversation entry is a slot), slot identification module 302 may determine whether the agent made an API call before making the statement (i.e., the identified slot).

In 510, if a slot relates to an API call, API identification module 303 may identify an API call corresponding to the identified slot. For example, API identification module 303 may compare the conversation entry corresponding to the slot with one or more API entries of the API log, and determine whether the slot relates to an API call. For example, slot identification module 302 may obtain a timestamp of the conversation entry and look for one or more API entries around the timestamp (by, e.g., comparing the timestamp(s) of the API entry/entries). If the timestamp of an API entry is within a threshold from the timestamp of the slot, slot identification module 302 may determine that API call be associated with the slot. Alternatively or additionally, API identification module 303 may identify an API call based on information relating to the API call and the content of the slot. The information relating to the API may include the specification and parameters of the API call, the information retrieved, and/or results returned in response to the API call. For example, API identification module 303 may retrieve the result of the API call from the API log indicating that no record has been found. API identification module 303 may also compare the result to the content of the slot provided by the agent during the conversation that “I was not able to locate it in our system.” API identification module 303 may further identify this API query call for the slot.

In 512, slot-API association module 304 may associate the identified API call with the identified slot. For example, slot-API association module 304 may establish a link between conversation entry No. 5 and API entry No. 1 (i.e., corresponding to a slot and its associated API call), which is shown as the dashed line in FIG. 4. Slot-API association module 304 may also establish a link between conversation entry No. 7 and API entry No. 2 (the dotted line) and a link between conversation entry No. 9 and API entry No. 3 (the dash-dot line) illustrated in FIG. 4. Alternatively or additionally, slot-API association module 304 may generate and store a data structure including the identified slot-API pair(s) in a conversation. Alternatively or additionally, slot-API association module 304 may generate and store a data structure including individual slot-API pair(s) identified in a conversation. In some embodiments, the data structure may include information relating to a slot-API pair. For example, the data structure may include time information relating to the slot and API call (e.g., a timestamp), the content of the conversation entry, the source of the conversation entry, API entry (including, e.g., specifications and parameters of the API call), information retrieved in response to the API call, the result returned in response to the API call, or the like, or a combination thereof. The association and/or data structure may be stored in a storage device (e.g., memory 220, database 140, etc.).

In some embodiments, slot-API association module 304 may generate and store one or more training samples based on the identified slot-API pair(s). For example, a training sample may include a slot as the input and the corresponding API call as the output. Alternatively or additionally, a training sample may include all identified slot-action pairs in a conversation. The generated training samples may be stored in a storage device (e.g., memory 220, database 140, etc.).

In 514, model generation module 305 may update (or generate) a customer inquiry processing model based on the associated API call and the slot. For example, model generation module 305 may update a customer inquiry processing model based on the training sample(s) generated based on the slot-action pair(s). In some embodiments, model generation module 305 may update (or generate) a customer inquiry processing model according to a plurality training samples generated based on a plurality of conversations (e.g., 100,000 training samples).

Alternatively or additionally, model generation module 305 may generate a conversation template based on the slot-action pair(s). An agent may access and use the conversation template to generate responses in a future interaction with a customer. For example, model generation module 305 may generate a conversation template for updating a phone number associated with a customer based on the slot-action pairs described in connection with FIG. 4. The conversation template may include canned messages including the greetings by an agent, scripts to ask for a customer's old phone number and new phone number. The conversation template may also include a set of rules for providing a response to the customer (e.g., if no record found in the system, then ask the customer to verify the old phone number). The conversation template may further include API calls to use in response to the customer's request (e.g., looking for the customer's profile information, updating the phone number, etc.). An agent (a bot or a human agent or a combination thereof) may use the conversation template to generate scripts and perform tasks in response to the customer's inquiry. For example, agent device 130 may suggest (or generate) one or more messages to be presented to (in the form of voice, text, or video) the customer based on the template and the information provided by the customer. Agent device 130 may also suggest (or make) API calls based on the template. Agent device 130 may further take actions based on the results of the API calls (e.g., updating the customer's phone number on record).

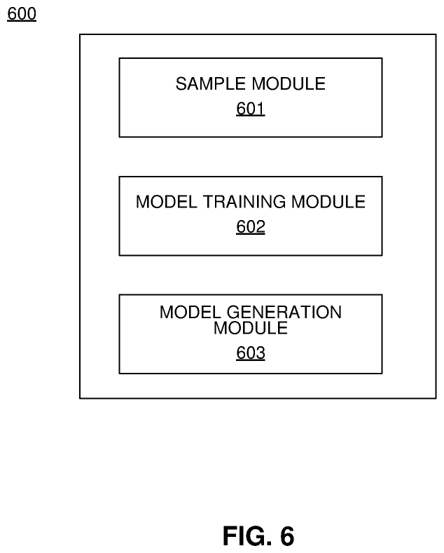

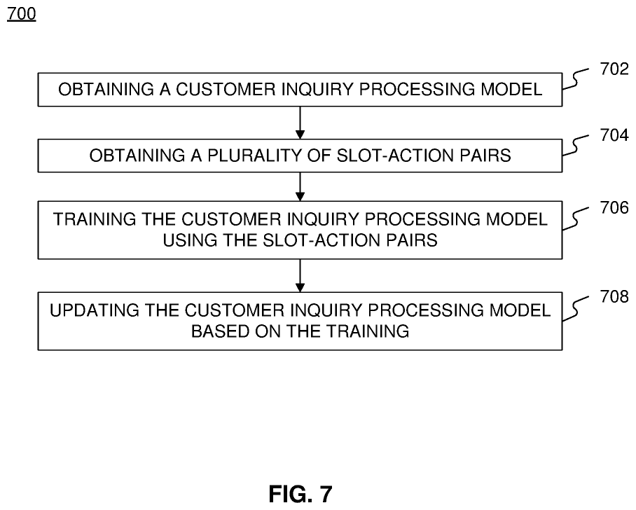

In some embodiments, step 514 may be performed by memory module 600 illustrated in FIG. 6 based on an exemplary process 700 illustrated in FIG. 7.

FIG. 6 depicts an embodiment of memory module 600 for generating (and/or updating) a customer inquiry processing model, in accordance with some embodiments of the present disclosure. Memory module may be implemented in memory 220 illustrated in FIG. 2. Memory module 600 may store a plurality of modules, and may be executable by at least one processor to perform various methods and processes disclosed herein. Further, it should be noted that memory module 300 may store more or fewer modules than those shown in FIG. 6, depending on implementation-specific considerations.

As illustrated in FIG. 6, memory module 600 may store software instructions to execute a sample module 601, a model training module 602, and a model generation module 603. Sample module 601 may include software instruction for obtaining a plurality of training samples for training a customer inquiry processing model. Model training module 602 may include software instruction for training a customer inquiry processing model according to the training samples. Model generation module 603 may include software instruction for generating (and/or updating) a customer inquiry processing model based on the training.

Sample module 601 may be configured to obtain a plurality of training samples for training the obtained customer inquiry processing model. The training samples may include a plurality of slot-action pairs.

Model training module 602 may be configured to obtain a customer inquiry processing model to be trained, and train the model based on the obtained training samples.

Model generation module 603 may be configured to determine a (or an updated) customer inquiry processing model after the training process.

FIG. 7 illustrate a flowchart of an exemplary process 700 for generating (and/or updating) a customer inquiry processing model, in accordance with some embodiments of the present disclosure. In one embodiment, the steps of process 700 may be performed by server 110 described above with reference to FIGS. 1 and 2.

In 702, model generation module 603 may obtain a customer inquiry processing model. The obtained customer inquiry processing model may be a preliminary customer inquiry processing model to be trained, which may be initialized and include initial parameters. Alternatively, the customer inquiry processing model to be trained may be an existing model that has been previously trained.

In some embodiments, a preliminary customer inquiry processing model having initial parameters, parameter values, and weights of nodes of the model. The preliminary customer inquiry processing model may be a convolutional neural network (CNN), a deep belief network (DBN), Stacked Auto-Encoders (SAE), a logistic regression (LR) model, a support vector machine (SVM), a decision tree model, a Naive Bayesian Model, a random forest model, a Restricted Boltzmann Machine (RBM), a Q-learning Model, or the like, or any combination a combination thereof. In some embodiments, the CNN model may include at least one of a convolutional layer, a Rectified Linear Unit (ReLU) layer, a fully connected layer or a pooling layer.

In 704, sample module 601 may obtain a plurality of training samples for training the obtained customer inquiry processing model. The training samples may include a plurality of slot-action pairs. A slot-action pair refers to a slot of information and a corresponding API call, and the related information. For example, a slot-action pair may include a customer name (e.g., Jack) and a corresponding API call initiated by the agent to query a database (e.g., database 307) for the customer's profile information (e.g., API=query {“name”: “Jack”}). The obtained slot-action pairs may include at least one slot-action pair determined according to process 500 described elsewhere in this disclosure. For example, the customer's name “Jack” (i.e., a slot) may be determined based on a sentence uttered by the customer during a phone call conversation with an agent in 504, and the corresponding API call may be identified in 508 and 510. An association between the slot and API call may be established in 512.

In 706, model training module 602 may train the customer inquiry processing model according to the obtained training samples. For example, model training module 602 may train a preliminary customer inquiry processing model by inputting a slot of a training sample into the model and comparing the output of the model with the corresponding API call (and/or the information retrieved and/or result returned). Model training module 602 may also modify parameters, parameter values, and/or weights of the nodes based on the results of the comparison.

In 708, model generation module 603 may determine a (or an updated) customer inquiry processing model after the training process (e.g., after running a certain number of training samples or till the accuracy of the model reaches a threshold).

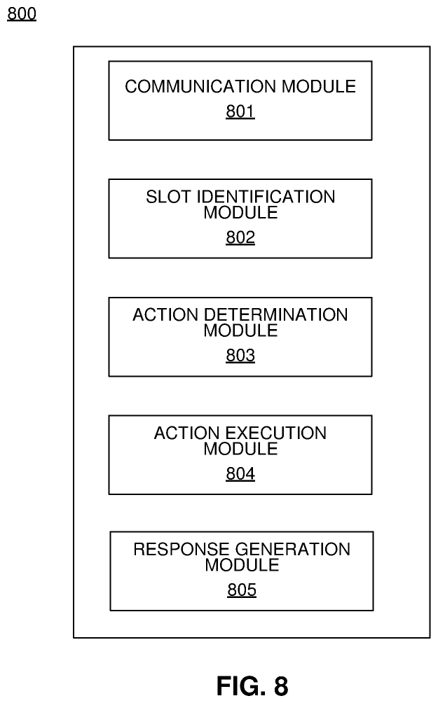

FIG. 8 depicts an embodiment of memory module 800 for processing a customer inquiry. Memory module may be implemented in memory 220 illustrated in FIG. 2. Memory module 800 may store a plurality of modules, and may be executable by at least one processor to perform various methods and processes disclosed herein. Further, it should be noted that memory module 800 may store more or fewer modules than those shown in FIG. 8, depending on implementation-specific considerations.

As illustrated in FIG. 8, memory module 800 may include a communication module 801, a slot identification module 802, an action determination module 803, an action execution module 804, and response generation module 805. Communication module 801 may be configured to receive a customer inquiry from a user device 120 associated with a customer. Slot identification module 802 may be configured to identify a slot of information from the customer inquiry. Action determination module 803 may be configured to whether an API call is needed to respond to the customer inquiry (or the identified slot) and if so, action determination module 803 may also determine an API call for the customer inquiry. Action execution module 804 may be configured to execute the identified API call. Response generation module 805 may be configured to generate a response based on the result of the executed API call.

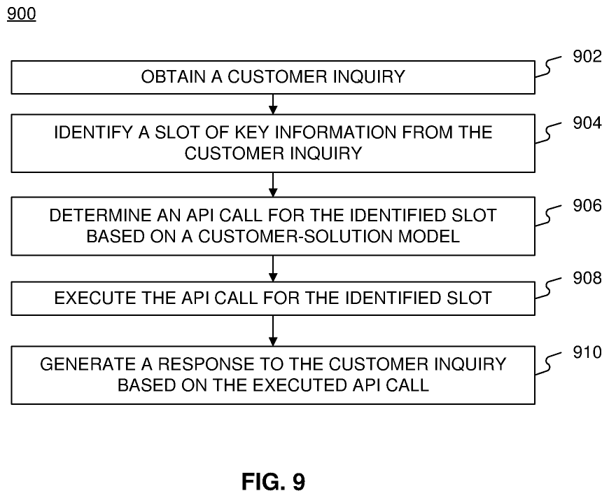

FIG. 9 illustrate a flowchart of an exemplary process 900 for processing a customer inquiry, in accordance with some embodiments of the present disclosure. In one embodiment, the steps of process 900 may be performed by server 110 and/or agent device 130. Alternatively, at least some of the steps of process 900 may be performed by user device 120.

In 902, communication module 801 may receive a customer inquiry (e.g., a new customer inquiry). For example, communication module 801 may receive a request from a user device 120 associated with a customer via network 150. The request may be in the form of a telephonic call, request for an online chat, email, posting on an online forum, SMS, MMS, or the like, or a combination thereof. Alternatively or additionally, the request may be transmitted to server 110 and/or agent device 130 through an application installed in user device 120.

In 904, slot identification module 802 may identify a slot of information from the customer inquiry. The identification of a slot may be based on a process as described elsewhere in this disclosure (e.g., in connection with step 504). For example, slot identification module 802 may identify the name of the customer (i.e., a slot of information) based on information provided by the customer in an online chat. As another example, slot identification module 802 may determine an intention of the customer (also a slot) to update his or her phone number. In some embodiments, slot identification module 802 may also determine a type of the slot as described elsewhere in this disclosure.

In 906, action determination module 803 may determine whether an API call is needed to respond to the customer inquiry (or the identified slot). If so, action determination module 803 may also determine an API call for the customer inquiry. For example, action determination module 803 may determine whether an API call is needed based on the type of the slot.

In some embodiments, action determination module 803 may obtain a customer inquiry processing model (trained or updated) and determine an API call based on the model. The obtained customer inquiry processing model may be a model generated according to a training process as described elsewhere in this disclosure (e.g., in connection with FIG. 7). Action determination module 803 may use the identified slot as the input of the model and obtain one or more API calls as the output of the model. For example, an identified slot may be an old phone number provided by the customer and the relevant context. Action determination module 803 may input the slot into the customer inquiry processing model and obtain an output of the model. The output may include an API query call to look up the customer's profile information. The output may also include specifications and parameters of the API call (e.g., the customer's name, phone number, database to search, etc.). As another example, action determination module 803 may input a slot indicating the customer's intention to update the phone number of record into the model and obtain an output including an API call to perform the task of updating the phone number for the customer.

In 908, action execution module 804 may execute the identified API call (if any). In some embodiments, action execution module 804 may automatically execute the identified API call(s). Alternatively, action execution module 804 may suggest the identified API call(s) to the agent (e.g., a human agent), who may approve the execution of the API call(s) or modify the API call(s).

In 910, response generation module 805 may generate a response based on the result of the executed API call. For example, a result returned from an API query call for a customer's profile information may indicate that there is no record for the phone number provided by the customer. According to the result, response generation module 805 may automatically generate a response such as “I am sorry. I was not able to find the phone number in our system. Can you verify the phone number for me?” As another example, action execution module 804 may execute an API call to update the phone number of record for the customer and receive a confirmation that the phone number has been updated (e.g., from database interface module 306). Response generation module 805 may generate a response based on the result of the API call indicating to the customer that the update has been completed.

Agent device 130 may also transmit the response to the customer via, for example, communication module 801 through network 150. Alternatively, response generation module 805 may generate a response based on the result of the API call, and the agent may approve or modify the response before it is transmitted to the customer.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, e.g., hard disks or CD ROM, or other forms of RAM or ROM, USB media, DVD, Blu-ray, Ultra HD Blu-ray, or other optical drive media.

Computer programs based on the written description and disclosed methods are within the skills of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The examples are to be construed as non-exclusive. Furthermore, the steps of the disclosed methods may be modified in any manner, including by reordering steps and/or inserting or deleting steps. It is intended, therefore, that the specification and examples be considered as illustrative only.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.”

What is claimed is:

1. A system for generating a model for processing customer inquiries, comprising:
one or more processors; and
one or more data storage devices storing instructions that, when executed, cause the one or more processors to perform operations comprising:
obtaining a conversation log comprising a plurality of conversation entries associated with a conversation between a customer and an agent;
identifying, from the conversation entries, a slot of key information;
determining that the identified slot relates to an application program interface (API) call;
obtaining an API log comprising a plurality of API calls associated with the conversation;
identifying an API call from the API calls included in the API call log based on the identified slot;
associating the identified slot with the corresponding API call; and
generating a customer inquiry processing model for processing a customer inquiry based on information relating to the identified slot and the corresponding API call.

2. The system of claim 1, wherein the operations further comprise:
obtaining a new customer inquiry for a new customer;
identifying a new slot of key information from the new customer inquiry;
determining, based on the customer inquiry processing model, an API call for the identified new slot;
executing the API call for the identified new slot; and
generating, based on the executed API call, a response to the new customer inquiry.

3. The system of claim 1, wherein generating a customer inquiry processing model comprising:
obtaining a preliminary customer inquiry processing model;
obtaining a plurality of slot-action pairs including a first slot-action pair, the first slot-action pair including the information relating to the identified slot and the corresponding API call;
training the preliminary customer inquiry processing model using the slot-action pairs; and
generating the customer inquiry processing model based on the training.

4. The system of claim 1, wherein identifying, from the conversation entries, a slot comprises:
identifying the slot from one of the conversation entries according to an identification process based on named-entity recognition.

5. The system of claim 1, wherein identifying, from the conversation entries, a slot comprises:
identifying the slot from one of the conversation entries according to an identification process based on statistic data.

6. The system of claim 1, wherein the operations further comprises:
determining a type of the identified slot.

7. The system of claim 6, wherein identifying an API call from the API calls comprises:
identifying an API call from the API calls based on the type of the identified slot.

8. The system of claim 1, wherein identifying an API call from the API calls comprises:
determining a timestamp associated with the identified slot;
determining a timestamp associated with an API call among the API calls;
comparing the timestamp associated with the identified slot and the timestamp associated with the API call; and
identifying the API call based on a result of the comparison.

9. The system of claim 1, wherein the operations further comprise:
generating a training sample based on the associated slot and API call, wherein generating the customer inquiry processing model comprises training the customer inquiry processing model based on a plurality of training samples including the generated training sample.

10. The system of claim 9, wherein the generated training sample comprises information retrieved by the API call or a result returned by the API call.

11. A computer-implemented method for processing a customer inquiry, comprising:
obtaining a conversation log comprising a plurality of conversation entries associated with a conversation between a customer and an agent;
identifying, from the conversation entries, a slot of key information;
determining that the identified slot relates to an application program interface (API) call;
obtaining an application program interface (API) log comprising a plurality of API calls associated with the conversation;
identifying an API call from the API calls included in the API call log based on the identified slot;
associating the identified slot with the corresponding API call; and
generating a customer inquiry processing model for processing a customer inquiry based on information relating to the identified slot and the corresponding API call.

12. The method of claim 11, further comprising:
obtaining a new customer inquiry for a new customer;
identifying a new slot of key information from the new customer inquiry;
determining, based on the customer inquiry processing model, an API call for the identified new slot;
executing the API call for the identified new slot; and
generating, based on the executed API call, a response to the new customer inquiry.

13. The method of claim 11, wherein generating a customer inquiry processing model comprising:
obtaining a preliminary customer inquiry processing model;
obtaining a plurality of slot-action pairs including a first slot-action pair, the first slot-action pair including the information relating to the identified slot and the corresponding API call;
training the preliminary customer inquiry processing model using the slot-action pairs; and
generating the customer inquiry processing model based on the training.

14. The method of claim 11, wherein identifying, from the conversation entries, a slot comprises:
identifying the slot from one of the conversation entries according to an identification process based on named-entity recognition.

15. The method of claim 11, wherein identifying, from the conversation entries, a slot comprises:
identifying the slot from one of the conversation entries according to an identification process based on statistic data.

16. The method of claim 11, further comprising:
determining a type of the identified slot.

17. The method of claim 16, wherein identifying an API call from the API calls comprises:
identifying an API call from the API calls based on the type of the identified slot.

18. The method of claim 11, wherein identifying an API call from the API calls comprises:
determining a timestamp associated with the identified slot;
determining a timestamp associated with an API call among the API calls;
comparing the timestamp associated with the identified slot and the timestamp associated with the API call; and
identifying the API call based on a result of the comparison.

19. The method of claim 11, further comprising:
generating a training sample based on the associated slot and API call, wherein generating the customer inquiry processing model comprises training the customer inquiry processing model based on a plurality of training samples including the generated training sample.

20. A non-transitory computer-readable medium storing instructions that, when executed by one or more processors of a system, cause the system to perform operations comprising:
obtaining a conversation log comprising a plurality of conversation entries associated with a conversation between a customer and an agent;
identifying, from the conversation entries, a slot of key information;
determining that the identified slot relates to an application program interface (API) call;
obtaining an API log comprising a plurality of API calls associated with the conversation;
identifying an API call from the API calls included in the API call log based on the identified slot;
associating the identified slot with the corresponding API call; and
generating a customer inquiry processing model for processing a customer inquiry based on information relating to the identified slot and the corresponding API call.
